(19) United States
(12) Patent Application Publication
(10) Pub. No.: US 2025/0258460 A1
(43) Pub. Date: Aug. 14, 2025

(54) COMMUNICATION SYSTEM AND IMAGE-FORMING APPARATUS

(71) Applicant: CANON KABUSHIKI KAISHA, Tokyo (JP)

(72) Inventor: KOSUKE YASAKI, Ibaraki (JP)

(21) Appl. No.: 19/046,395

(22) Filed: Feb. 5, 2025

(30) Foreign Application Priority Data
Feb. 8, 2024 (JP) 2024-018020

(51) Int. Cl. G03G 21/18; G03G 15/02; G03G 15/043

(52) U.S. Cl. CPC G03G 21/1882; G03G 15/0266; G03G 15/043

(57) ABSTRACT

A communication system includes a plurality of devices, a communication interface connected to the devices, a first memory storing setting information to be sent to the devices, a second memory storing control information indicating an operating mode, and a processor that controls operations of the communication interface by writing information into the second memory. The first memory stores first information to be applied separately to the devices, and second information to be applied in common to the devices. The communication interface is configured to: when the control information in the second memory indicates a first mode, read out the first information from the first memory and send it to the devices; and when the control information in the second memory indicates a second mode, read out the second information from the first memory and send it to the devices.

### BACKGROUND

### Field of the Disclosure

The present disclosure relates to a communication system and an image-forming apparatus.

### Description of the Related Art

An electrophotographic image-forming apparatus forms an image by exposing a rotationally-driven photosensitive member with light to form an electrostatic latent image on it and developing the electrostatic latent image with toner. Among others, a solid-state exposure type exposure apparatus, that images light from a light-emitting element array onto a surface of a photosensitive member utilizing a rod lens array, is attracting attention because its downsizing, enhancing quietness, and cost reduction are easier compared to a laser-scanning type exposure apparatus.

Japanese Patent Laid-Open No. 2021-35765 discloses an example of a solid-state exposure apparatus. In the exposure apparatus disclosed in Japanese Patent Laid-Open No. 2021-35765, a plurality of light-emitting chips each having a light-emitting element array are connected to a communication interface by a plurality of signal lines, and each light-emitting chip has an internal register for storing operation setting values.

Japanese Patent Publication No. 4193148 discloses a communication system for communicating with a plurality of devices in an image-forming apparatus. With the communication system according to Japanese Patent Publication No. 4193148, whether common setting values are sent to a plurality of devices at once or separate setting values are sent to the plurality of devices separately can be switched in accordance with a mode specified by an administrator in advance through a user interface (UI).

Even in a solid-state exposure apparatus, if it is possible to switch between sending separate setting information and sending common setting information to the plurality of light-emitting chips in a flexible manner, the load of the communication for setting the light-emitting chips is reduced and the communication time is shortened, which is beneficial in terms of productivity. However, the method in which a mode is specified in advance through the UI, described in Japanese Patent Publication No. 4193148, is unfavorable for real-time operations, and is particularly unsuitable for controlling operations while a job is being executed in an image-forming apparatus.

### SUMMARY

In light of the foregoing, embodiments of the present disclosure aim to provide improved communication control that makes it possible to flexibly switch between sending separate setting information and sending common setting information to a plurality of devices.

According to a first aspect, there is provided a communication system including a plurality of devices, a communication interface connected to the plurality of devices over a plurality of signal lines, a first storage unit configured to store setting information to be sent from the communication interface to the plurality of devices, a second storage unit configured to store control information indicating an operating mode of the communication interface, and a processor configured to control operations of the communication interface by writing the control information into the second storage unit. The first storage unit is configured to store a plurality of pieces of separate setting information to be applied separately to the plurality of devices, and common setting information to be applied in common to the plurality of devices. The communication interface is configured to, in a case where the control information written into the second storage unit includes a first value indicating a first operating mode, read out the plurality of pieces of separate setting information from the first storage unit and send the read-out pieces of separate setting information to the plurality of devices; and in a case where the control information written into the second storage unit includes a second value indicating a second operating mode, read out the common setting information from the first storage unit and send the read-out common setting information to the plurality of devices.

According to a second aspect, there is provided an image-forming apparatus that forms an image on a sheet, the image-forming apparatus including a photosensitive member and an exposure apparatus configured to expose the photosensitive member. The exposure apparatus includes the communication system according to the first aspect, and each of the plurality of devices is a light-emitting chip having a light-emitting element array used to expose the photosensitive member.

Further features of various embodiments will become apparent from the following description of exemplary embodiments (with reference to the attached drawings).

### BRIEF DESCRIPTION OF THE DRAWINGS

FIG. 1 is a configuration diagram illustrating a schematic configuration of an image-forming apparatus according to an embodiment.

FIG. 2A is an explanatory diagram illustrating a configuration of a photosensitive member according to an embodiment.

FIG. 2B is an explanatory diagram illustrating a configuration of an exposure head according to an embodiment.

FIG. 3A is a first explanatory diagram illustrating a configuration of a printed circuit board of the exposure head according to an embodiment.

FIG. 3B is a second explanatory diagram illustrating a configuration of a printed circuit board of the exposure head according to an embodiment.

FIG. 4 is an explanatory diagram illustrating light-emitting chips and light-emitting element arrays in the light-emitting chips according to an embodiment.

FIG. 5 is a plan view illustrating a schematic configuration of a light-emitting chip according to an embodiment.

FIG. 6 is a cross-sectional view illustrating a schematic configuration of a light-emitting element according to an embodiment.

FIG. 7 is a block diagram illustrating an example of a configuration of a communication system that can be provided in an exposure apparatus according to an embodiment.

FIG. 8 is a block diagram illustrating an example of a detailed configuration of the light-emitting chip according to an embodiment.

FIG. 9 is a circuit diagram illustrating a partial configuration of a current drive unit corresponding to one light-emitting element.

FIG. 10 is a timing chart of sending of image data to a plurality of light-emitting chips.

FIG. 11A is a timing chart of sending of setting data to a plurality of light-emitting chips.

FIG. 11B is a timing chart of receiving of setting data from a plurality of light-emitting chips.

FIG. 12 is a timing chart of sending of disablement data to a plurality of light-emitting chips.

FIG. 13 is a state transition diagram illustrating restrictions on transitions of an operating state of an interface circuit of a light-emitting chip.

FIG. 14 is a timing chart of data communication in a scenario in which an error in interpretation of identification information occurs while image data is being sent.

FIG. 15 is a table illustrating an example of a configuration of a register of an image controller according to an embodiment.

FIG. 16A is a timing chart of sending of setting data in a separate setting mode.

FIG. 16B is a timing chart of sending of setting data in a common setting mode.

FIG. 17 is a flowchart illustrating an example of a flow of chip setting processing according to an embodiment.

FIG. 18 is a flowchart illustrating an example of a flow of job control processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### 1. Schematic Configuration of Image-Forming Apparatus

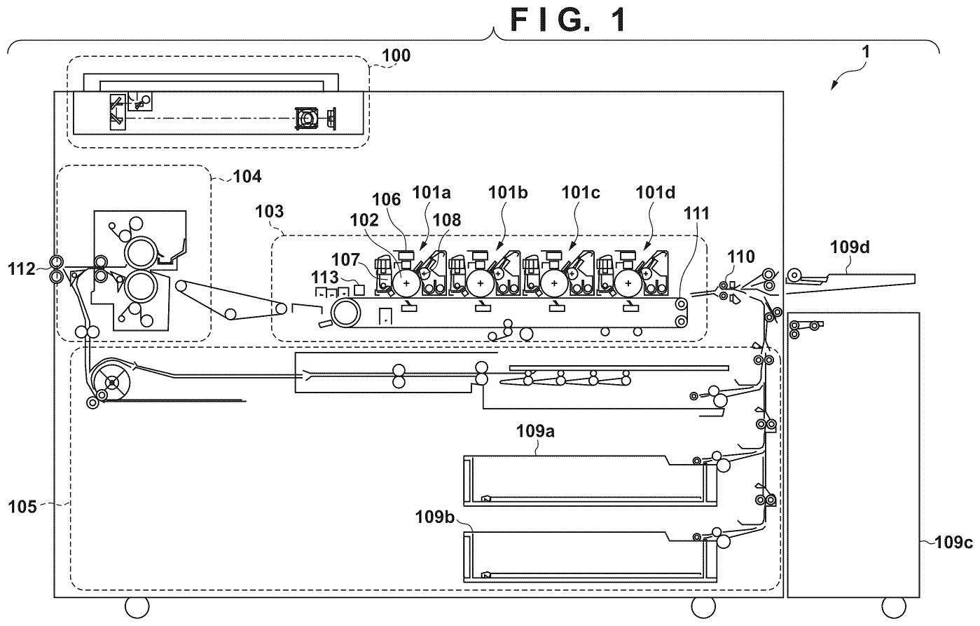

FIG. 1 shows an example of a schematic configuration of an image-forming apparatus 1 according to an embodiment. The image-forming apparatus 1 includes a reading unit 100, an image-making unit 103, a fixing unit 104, a transport unit 105, and a control unit (not shown) that is capable of communication with these units. The reading unit 100 optically reads an original placed on a platen and generates read image data. The image-making unit 103 forms an image on a sheet based on the read image data generated by the reading unit 100 or based on print image data received from an external device via a network, for example.

The image-making unit 103 includes image-forming units 101a, 101b, 101c, and 101d. The image-forming units 101a, 101b, 101c, and 101d form toner images in black, yellow, magenta, and cyan, respectively. The image-forming units 101a, 101b, 101c and 101d have the same configuration, and are also referred to collectively as image-forming units 101 below. A photosensitive member 102 of the image-forming unit 101 is driven to rotate in the clockwise direction in the figure during image formation. A charger 107 electrically charges the photosensitive member 102. An exposure head 106 exposes the photosensitive member 102 with light to form an electrostatic latent image on a surface of the photosensitive member 102. A developer 108 develops the electrostatic latent image on the photosensitive member 102 with toner to form a toner image. The toner image formed on the surface of the photosensitive member 102 is transferred to a sheet that is being transported on a transfer belt 111. A color image containing four color components, namely black, yellow, magenta, and cyan, can be formed by transferring the toner images of the four photosensitive members 102 to the sheet in a superimposed manner.

The transport unit 105 controls feed and transport of sheets. Specifically, the transport unit 105 feeds a sheet from a unit designated from among internal storage units 109a and 109b, an external storage unit 109c, and a manual feed unit 109d to a transport path in the image-forming apparatus 1. The fed sheet is transported to a registration roller 110. The registration roller 110 transports the sheet onto the transfer belt 111 at an appropriate timing such that the toner image of each photosensitive member 102 is transferred to the sheet. As mentioned above, the toner images are transferred to the sheet while the sheet is transported on the transfer belt 111. The fixing unit 104 fixes the toner images to the sheet by heating and pressurizing the sheet to which the toner images have been transferred. After the toner images have been fixed, the sheet is discharged to outside the image-forming apparatus 1 by a discharge roller 112. An optical sensor 113 is located at a position facing the transfer belt 111. The optical sensor 113 optically reads a test chart formed on the transfer belt 111 by the image-forming units 101. In a case where an error in an image-forming range (for example, color misalignment) is detected for the test chart read by the optical sensor 113, a CPU 701 described below performs control for compensating for the error when executing subsequent jobs.

Although an example in which the toner image is directly transferred from each photosensitive member 102 to the sheet on the transfer belt 111 has been described here, the toner image may alternatively be transferred indirectly from each photosensitive member 102 to the sheet via an intermediate transfer member. Further, although an example of forming a color image using toner of multiple colors has been described here, the technology according to the present disclosure is also applicable to an image-forming apparatus that forms a monochrome image using toner of a single color.

The control unit that may be one or more processors or processing circuitry not illustrated in FIG. 1, manages states of the reading unit 100, the image-making unit 103, the fixing unit 104 and the transport unit 105, and controls operations of these units so that print jobs are smoothly carried out. There may be provided a multifunction peripheral (MFP) control unit that controls operations of the entire apparatus and a print control unit that controls an image-forming operation, and execution of print jobs may be controlled by these control units working in conjunction with each other.

### 2. Basic Configuration of Exposure Head

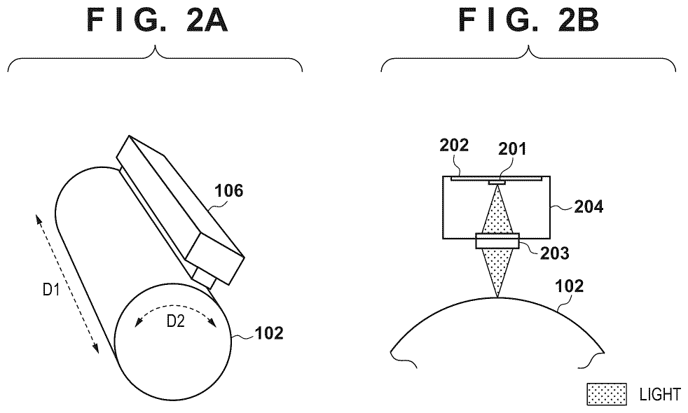

FIGS. 2A and 2B show the photosensitive member 102 and the exposure head 106. The exposure head 106 includes a light-emitting element array 201, a printed circuit board 202 on which the light-emitting element array 201 is mounted, a rod lens array 203, and a housing 204 supporting the printed circuit board 202 and the rod lens array 203. The photosensitive member 102 has a cylindrical shape. The exposure head 106 is arranged such that the longitudinal direction thereof is parallel to an axial direction D1 corresponding to the rotational axis of the photosensitive member 102, and a face of the exposure head 106 to which the rod lens array 203 is attached faces the surface of the photosensitive member 102. While the photosensitive member 102 rotates in a circumferential direction D2, the light-emitting element array 201 of the exposure head 106 emits light, and the rod lens array 203 images the light onto the surface of the photosensitive member 102.

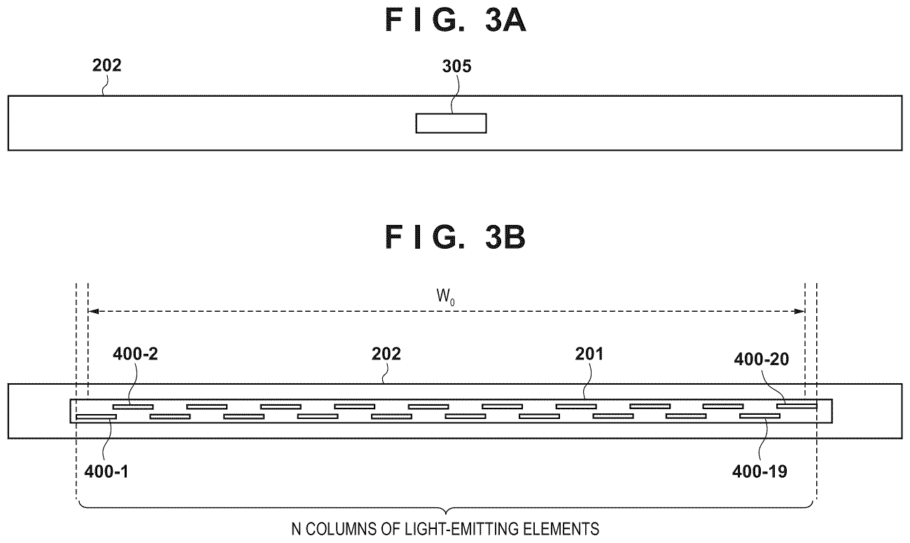

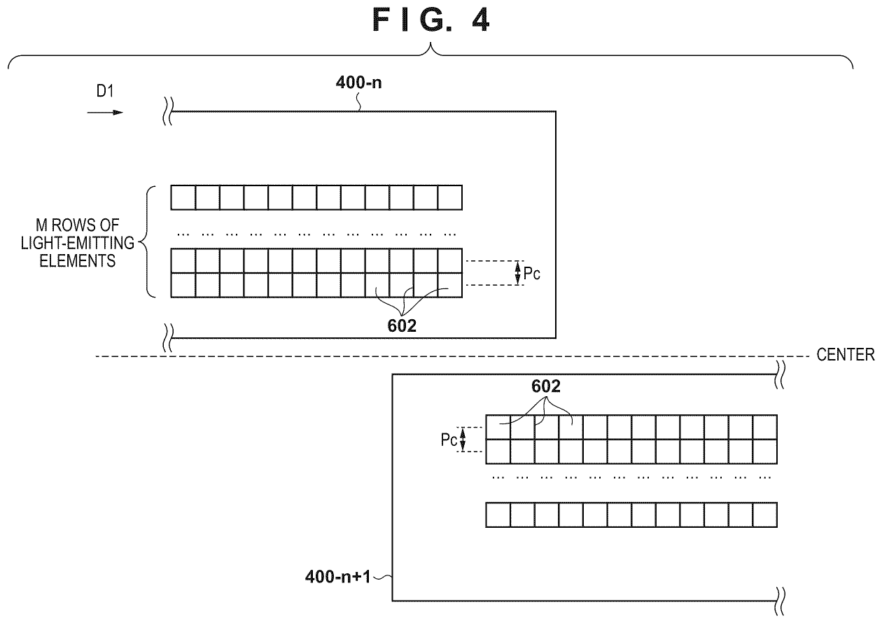

FIGS. 3A and 3B show an example of a configuration of the printed circuit board 202. Note that FIG. 3A shows a face on which a connector 305 is mounted, and FIG. 3B shows a face on which the light-emitting element array 201 is mounted (a face on the side opposite to the face on which the connector 305 is mounted). FIG. 4 shows light-emitting chips 400, and arrays of light-emitting elements 502 within the light-emitting chips 400.

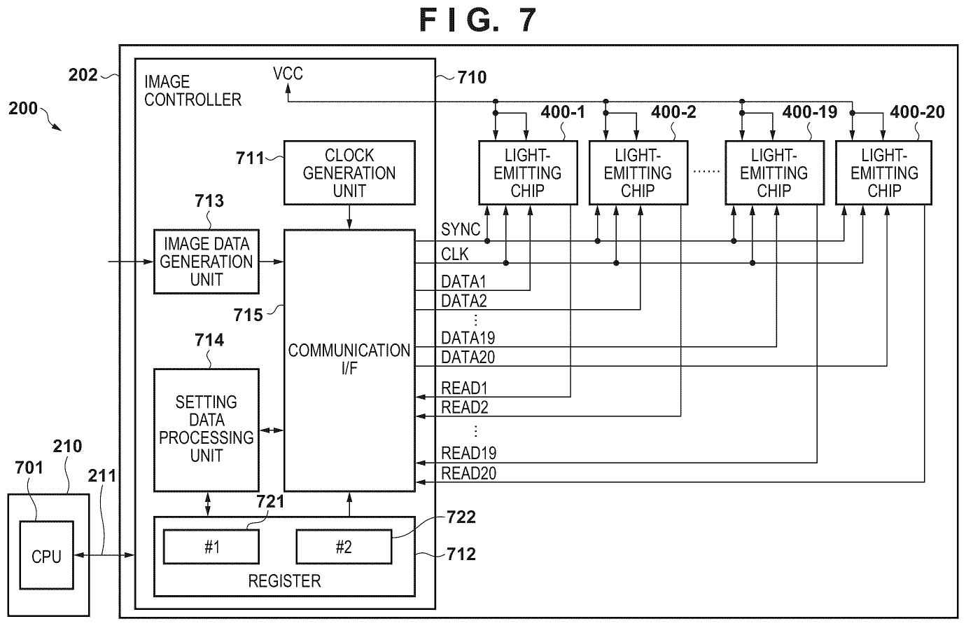

In the present embodiment, the light-emitting element array 201 has a plurality of light-emitting elements that are arranged two-dimensionally. The light-emitting element array 201 as a whole includes light-emitting elements in N columns in the axial direction D1 and M rows in the circumferential direction D2 of the photosensitive member, where M and N are integers. In the example of FIG. 3B, the light-emitting element array 201 is constituted by separate twenty light-emitting chips 400-1 to 400-20, each of which includes a subset of the entire plurality of light-emitting elements, and the light-emitting chips 400-1 to 400-20 are arranged in a staggered manner along the axial direction D1. The light-emitting chips 400-1 to 400-20 are also referred to collectively as light-emitting chips 400. As illustrated in FIG. 3B, the range occupied by the entire light-emitting elements of the twenty light-emitting chips in the axial direction D1 is wider than the range occupied by the maximum width W₀ of input image data. Accordingly, some light-emitting elements located at both ends in the axial direction D1 may not be used for exposing the photosensitive member 102 unless an error in the image-forming range is detected. Each light-emitting chip 400 on the printed circuit board 202 is connected to the image controller 710 (FIG. 7) via the connector 305. In the following, there are cases where the smaller branch number side of the light-emitting chips 400-1 to 400-20 arranged in the axial direction D1 is referred to as “left” and the larger branch number side as “right”, for convenience of description. For example, the light-emitting chip 400-1 is a light-emitting chip 400 at the left end, and the light-emitting chip 400-20 is a light-emitting chip at the right end.

The number J of light-emitting elements 602 arranged in each row of one light-emitting chip 400 (J=N/20) may be equal to 748 (J=748, N=14960), for example. Meanwhile, the number M of light-emitting elements 602 arranged in each column of one light-emitting chip 400 may be equal to 4 (M=4), for example. That is to say, in an example embodiment, each light-emitting chip 400 has 2992 (=748*4) light-emitting elements 602 in total, with 748 elements in the axial direction D1 and 4 elements in the circumferential direction D2. The interval Pc between central points of light-emitting elements 602 adjoining in the circumferential direction D2 may be about 21.16 μm corresponding to a resolution of 1200 dpi, for example. The interval between central points of light-emitting elements 602 adjoining in the axial direction D1 may also be about 21.16 μm and, in this case, 748 light-emitting elements 602 occupy the length of about 15.8 mm in the axial direction D1, which corresponds to the width of the light-emitting element array of one light-emitting chip 400 in the axial direction D1. The width of the light-emitting element arrays of the twenty light-emitting chips 400-1 to 400-20 in the axial direction D1 is approximately 316 mm.

In a practical example, M is larger than one and, as illustrated in FIG. 4, the light-emitting elements 602 may be arranged completely in a grid-like pattern in each light-emitting chip 400. In another practical example, M is equal to one, and the light-emitting elements 602 form a simple one-dimensional array in each light-emitting chip 400. In yet another practical example, M is larger than one and, M light-emitting elements 602 of each column may be arranged in a staircase pattern (that is, they are shifted from each other by 1/M of the pixel pitch in the axial direction) or in a partially-staircase pattern in each light-emitting chip 400. In a case where the number of rows M of the light-emitting element array is larger than one, a pixel region (also referred to as a spot) corresponding to each pixel of each line on the surface of the photosensitive member 102 is exposed to light multiple times by the M light-emitting elements 602. This makes it possible to form an image with high density by augmenting an amount of light for the exposure.

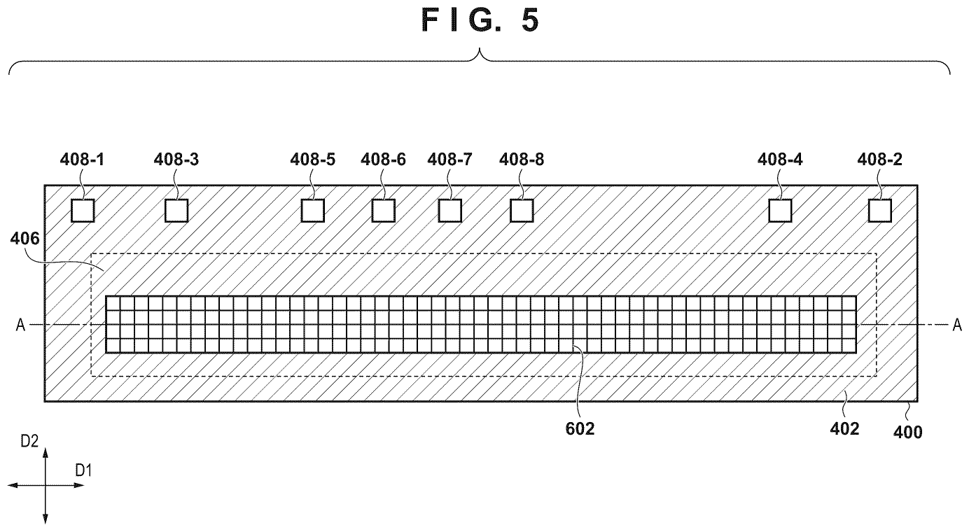

FIG. 5 is a plan view of a schematic configuration of the light-emitting chip 400. The plurality of light-emitting elements 602 of each light-emitting chip 400 are formed on a light-emitting substrate 402, which is a silicon substrate, for example. The light-emitting substrate 402 has a circuit portion 406 for driving the plurality of light-emitting elements 602. Pads 408-1 to 408-8 are connected to signal lines for communicating with the image controller 710, power lines for connection with power supplies, and ground lines for connection with ground. The signal lines, the power lines, and the ground lines may be gold wires, for example.

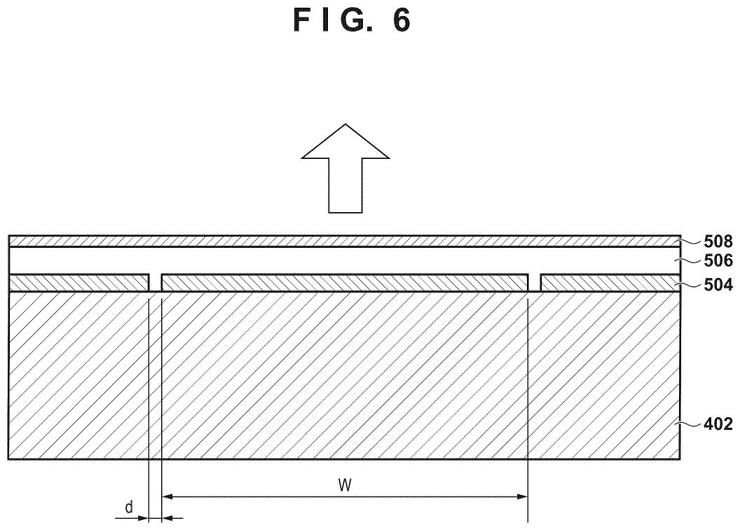

FIG. 6 illustrates a partial cross section taken along the line A-A of FIG. 5. A plurality of lower electrodes 504 are formed on the light-emitting substrate 402, which is a silicon substrate. A gap with length d is provided between two adjoining lower electrodes 504. A light-emitting layer 506 is provided on the lower electrodes 504, and an upper electrode 508 is provided on the light-emitting layer 506. The upper electrode 508 is one common electrode for the plurality of lower electrodes 504. When a voltage is applied between the lower electrodes 504 and the upper electrode 508, the light-emitting layer 506 emits light as a result of electric current flowing from the lower electrodes 504 to the upper electrode 508. Thus, one lower electrode 504 and partial regions of the light-emitting layer 506 and the upper electrode 508 that correspond to the lower electrode 504 constitute one light-emitting element 602. That is, in the present embodiment, the light-emitting substrate 402 includes a plurality of light-emitting elements 602.

For example, an organic EL film can be used for the light-emitting layer 506. The upper electrode 508 is constituted by a transparent electrode made of indium tin oxide (ITO) or the like, for example, so as to allow the light-emission wavelength of the light-emitting layer 506 to pass through. Note that, in the present embodiment, the entire upper electrode 508 allows the light-emission wavelength of the light-emitting layer 506 to pass through, but the entire upper electrode 508 does not necessarily allow the light-emission wavelength to pass through. Specifically, it is sufficient that a partial region through which light from each light-emitting element 602 passes allows the light-emission wavelength to pass through.

Note that, in FIG. 6, one continuous light-emitting layer 506 is formed, but a plurality of light-emitting layers 506 each having a width equal to the width W of a corresponding lower electrode 504 may alternatively be formed on the respective lower electrodes 504. Further, in FIG. 6, the upper electrode 508 is formed as one common electrode for the plurality of lower electrodes 504; but, a plurality of upper electrodes 508 each having a width equal to the width W of a corresponding lower electrode 504 may alternatively be formed in correspondence with the respective lower electrodes 504. Further, a first plurality of lower electrodes 504, out of the lower electrodes 504 of each light-emitting chip 400, may be covered by a first light-emitting layer 506, and a second plurality of lower electrodes 504 may be covered by a second light-emitting layer 506. Similarly, a first upper electrode 508 may be formed in common for a first plurality of lower electrodes 504, out of the lower electrodes 504 of each light-emitting chip 400, and a second upper electrode 508 may be formed in common for a second plurality of lower electrodes 504. With such a configuration as well, one lower electrode 504 and regions of the light-emitting layer 506 and the upper electrode 508 that correspond to the lower electrode 504 constitute one light-emitting element 602.

### 3. Configuration of Communication System

This section will describe an example of a configuration of a communication system involved in the communication of data for light emission control in the exposure head 106. Although only configurations for a single color component will be described herein for the sake of brevity, the same configurations may be provided for a plurality of color components, and parts of the configurations described may be the same throughout the plurality of color components.

FIG. 7 is a block diagram illustrating an example of the configuration of a communication system 200 that can be mounted in the exposure head 106. Referring to FIG. 7, the communication system 200 includes the CPU 701, the image controller 710, and the plurality (twenty, in the embodiment illustrated here) of light-emitting chips 400-1 to 400-20. In the communication system 200, each light-emitting chip 400 is a slave device that passively participates in communication.

The CPU 701 is a processor that controls the operations of the exposure head 106. In the present embodiment, the image controller 710 is implemented on the printed circuit board (a first board) 202 with the light-emitting chips 400-1 to 400-20, and the CPU 701 is implemented on a control board (a second board) 210 different from the printed circuit board. The printed circuit board 202 and the control board 210 are connected to each other by a communication line 211. The communication line 211 may be a serial communication line (e.g., a serial communication cable). As will be described in detail below, the CPU 701 writes information into a register 712 of the image controller 710 over the serial communication line 211. For example, the CPU 701 controls the operations of a communication interface 715 by writing control information into the register 712.

The image controller 710 includes a clock generation unit 711, the register 712, an image data generation unit 713, a setting data processing unit 714, and a communication interface (I/F) 715. The communication I/F 715 is connected to the plurality of light-emitting chips 400 via a plurality of signal lines. For example, a signal line between the communication I/F 715 and an n-th light-emitting chip 400-n includes a data signal line DATAn, a data signal line READn, a clock signal line CLK, and a synchronization signal line SYNC. The data signal line DATAn is a signal line used to send data to the light-emitting chip 400-n. The data signal line READn is a signal line for reading out data from the light-emitting chip 400-n. The clock signal line CLK is a signal line that carries a clock signal generated by the communication I/F 715 on the basis of a reference clock signal from the clock generation unit 711. The synchronization signal line SYNC is a signal line that carries a line synchronization signal indicating a periodic exposure timing of each line in the photosensitive member 102.

The clock generation unit 711 generates the reference clock signal, which has a frequency set in advance, and outputs the generated reference clock signal to the communication I/F 715.

The register 712 stores information related to communication between the communication I/F 715 and the plurality of light-emitting chips 400. Although FIG. 7 illustrates the register 712 as an element separate from the setting data processing unit 714 and the communication I/F 715, the setting data processing unit 714 and the communication I/F 715 may be an integrated control chip, and the register 712 may be part of such a control chip. As illustrated, the register 712 has a first storage area (first storage unit) 721 and a second storage area (second storage unit) 722 that is different from the first storage area 721.

The first storage area 721 stores setting information to be transmitted from the communication I/F 715 to the plurality of light-emitting chips 400. The setting information can include, for example, at least one of control parameters indicating the following setting values:
Adjustment values for light intensity of the light-emitting element arrays
On/off of “power-saving mode”
Drive stop instructions for the light-emitting elements

An adjustment value for light intensity of a light-emitting element array may indicate, for example, an offset relative to a reference value of drive current to be supplied to the light-emitting elements. Typically, the adjustment values for light intensity are determined separately during the post-production inspections of the light-emitting chips so as to eliminate unevenness in the light intensity. An adjustment value may be determined for each of groups of light-emitting elements in a light-emitting chip. “Power-saving mode” refers to a mode in which the application of a constant voltage to the drive circuit of the light-emitting element array is stopped in each light-emitting chip 400. When the power-saving mode is on, the light-emitting chip 400 reduces power consumption by stopping the application of the voltage to the drive circuit of the light-emitting element array. When the power-saving mode is off, a voltage is applied to the drive circuit of the light-emitting element array, and the light-emitting elements 602 emit light in response to inputs of drive signals indicating that light emission should be on. The drive stop instruction of the light-emitting elements is an instruction for stopping emission of light from all the light-emitting elements 602 in the light-emitting element array of each light-emitting chip 400 at once.

The second storage area 722 stores control information indicating an operating mode of the communication I/F 715. The control of communication based on the control information stored in the second storage area 722 will be described in detail below.

The image data generation unit 713 performs image processing on image data received from the reading unit 100 or the external apparatus, and generates image data in a binary bitmap format for controlling the emission of light from the light-emitting elements 602 of the plurality of light-emitting chips 400 to turn on and off. The image processing here can include, for example, raster conversion, tone correction, color conversion, and halftone processing. The image data generation unit 713 outputs the generated image data to the communication I/F 715 as input image data.

The setting data processing unit 714 reads out the setting information that has been written into the first storage area 721 of the register 712, and outputs setting data, including the read-out setting information and corresponding address information, to the communication I/F 715. Here, the address information indicates an address to which the setting information is to be written within the register of the light-emitting chip 400. The setting data processing unit 714 also receives the setting information read out from the register of each light-emitting chip 400 through the communication I/F 715, and outputs the received setting information to the CPU 701.

The communication I/F 715 is an interface that mediates communication between the image controller 710 and the light-emitting chips 400-1 to 400-20. The communication I/F 715 divides the input image data input from the image data generation unit 713 into twenty segments, and sends signal sequences corresponding to those segments to the light-emitting chips 400-1 to 400-20 in parallel, for example. At this time, the signal sequence of the i-th segment is given predetermined identification information according to the signal format (described below), and is sent to a light-emitting chip 400-i via a data signal line DATAi.

The communication I/F 715 also sends signal sequences, corresponding to the setting data input from the setting data processing unit 714, to the light-emitting chips 400-1 to 400-20. At this time, the signal sequence of the setting data for the light-emitting chip 400-i is given predetermined identification information and access control information according to the signal format (described below), and is sent to the light-emitting chip 400-i via the data signal line DATAi. Here, the access control information is information instructing the light-emitting chip 400-i to write setting information into the register. The communication I/F 715 can also read out setting information from the register of the light-emitting chip 400-i. For example, the communication I/F 715 sends a signal sequence, including access control information instructing the readout of the setting information and address information specifying an address, to the light-emitting chip 400-i via the data signal line DATAi. The light-emitting chip 400-i then reads out the setting information that has been written in the specified address, and sends the read-out setting information back to the communication I/F 715 via a data signal line READi.

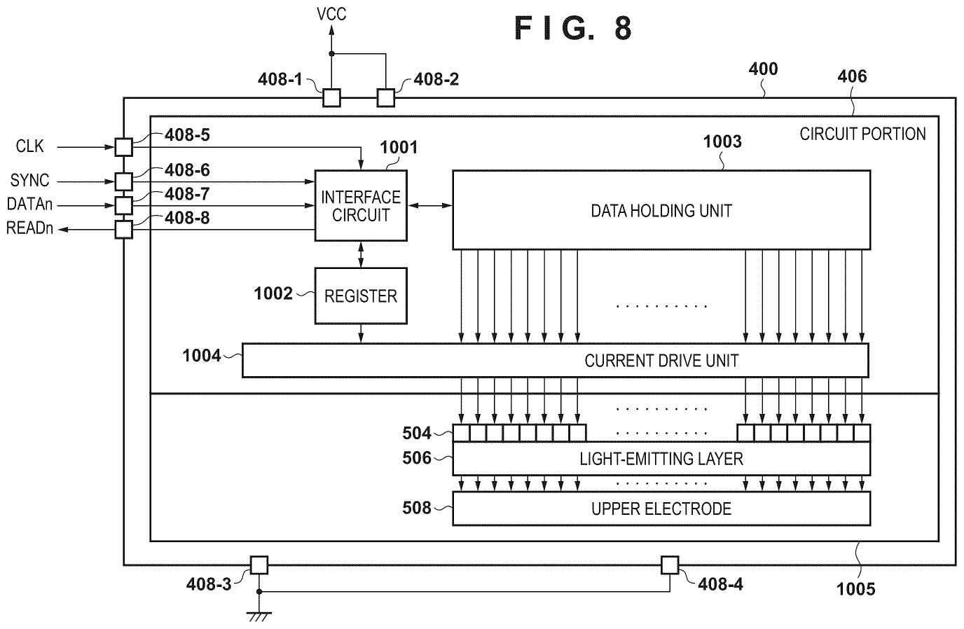

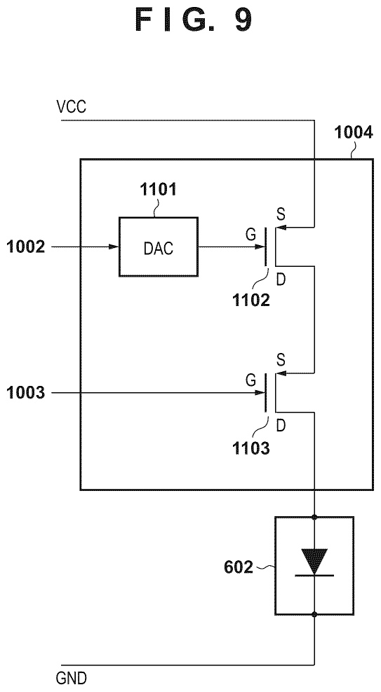

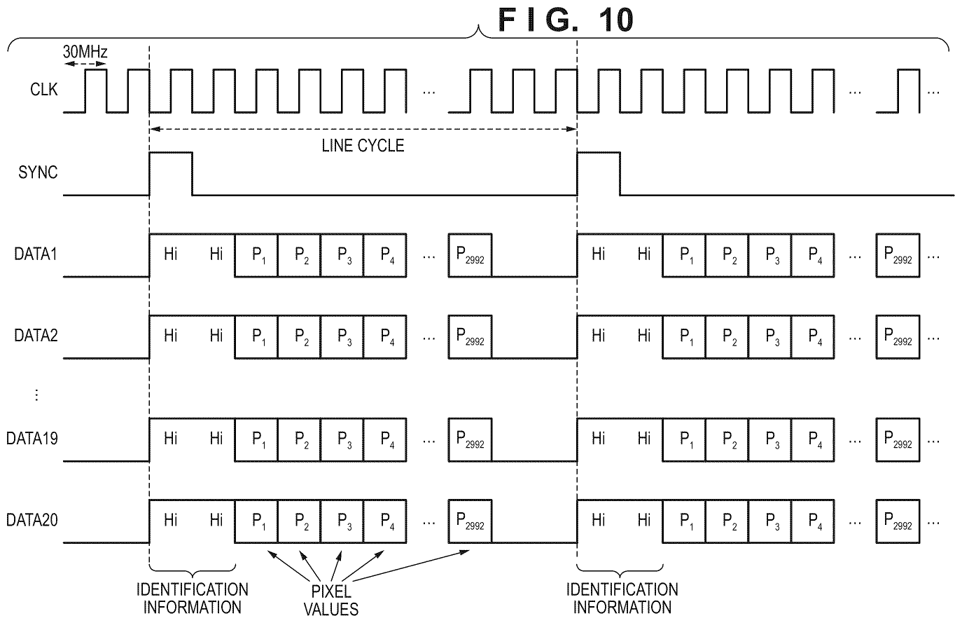

FIG. 8 is a block diagram illustrating an example of a detailed configuration of one light-emitting chip 400 (the n-th light-emitting chip 400-n) as a slave device. Referring to FIG. 8, the light-emitting chip 400 includes a circuit portion 406, a light-emitting element array 1005, and eight pads 408-1 to 408-8, also illustrated in FIG. 5. The circuit portion 406 includes an interface (I/F) circuit 1001, a register 1002, a data holding unit 1003, and a current drive unit 1004. The I/F circuit 1001, the register 1002, and the data holding unit 1003 are digital circuits, and the current drive unit 1004 is an analog circuit. The light-emitting element array 1005 is a one- or two-dimensional array of light-emitting elements 602 used to form an image. The pad 408-1 and the pad 408-2 are connected to a source voltage VCC by power lines. Each circuit in the circuit portion 406 of the light-emitting chip 400 is supplied with power by this source voltage VCC. The pad 408-3 and the pad 408-4 are grounded by ground lines. Each circuit in the circuit portion 406 and an upper electrode 508 are grounded through the pad 408-3 and the pad 408-4. The signal lines CLK, SYNC, DATAn, and READn are connected to the I/F circuit 1001 via the pads 408-5, 408-6, 408-7, and 408-8, respectively.

The I/F circuit 1001 is an interface that mediates communication between each light-emitting chip 400 and the image controller 710. The register 1002 is a storage unit (e.g., a semiconductor memory) that stores setting information for setting the operations of the light-emitting element array 1005. The data holding unit 1003 includes a set of latch circuits that hold J×M signal values of the image data received from the communication I/F 715 through the I/F circuit 1001. The data holding unit 1003 outputs drive signals indicating respective signal values to the current drive unit 1004 in parallel at timings indicated by the line synchronization signal. The current drive unit 1004 drives the light-emitting elements 602 constituting the light-emitting element array 1005 in accordance with the drive signals input from the data holding unit 1003. The light-emitting element array 1005 is an array of the light-emitting elements 602 used to expose the photosensitive member 102.

In addition to the drive signals, a light emission strength (light intensity) value indicated by the setting information stored in the register 1002 is supplied to the current drive unit 1004. FIG. 9 illustrates an example of part of the configuration of the current drive unit 1004, which is a drive circuit corresponding to one light-emitting element 602. Referring to FIG. 9, the current drive unit 1004 includes a digital-to-analog converter (DAC) 1101, a first transistor 1102, and a second transistor 1103. The DAC 1101 performs digital-to-analog conversion on the digital value of the light emission strength stored in the register 1002 (a current setting value), and outputs the corresponding analog signal to the gate of the first transistor 1102. The first transistor 1102 is a current amplification circuit, and may be a P-channel MOSFET, for example. The source of the first transistor 1102 is connected to the source voltage VCC. The drain of the first transistor 1102 is connected to the source of the second transistor 1103. The first transistor 1102 draws current, of a magnitude dependent on the current amount of the analog signal input to the gate, from the source and outputs that current to the drain. The second transistor 1103 is a switching circuit, and may be a P-channel MOSFET, for example. A drive signal (indicating whether light emission is on or off) from the data holding unit 1003 is input to the gate of the second transistor 1103. The drain of the second transistor 1103 is connected to a lower electrode 504 of the light-emitting element 602. When the drive signal input to the gate indicates that light emission is on (e.g., is at high level), the second transistor 1103 outputs the current input to the source to the light-emitting element 602 via the drain. Accordingly, during a period in which the drive signal indicates that light emission is on, current of a magnitude corresponding to the setting value stored in the register 1002 is supplied to the light-emitting element 602, and each light-emitting element 602 emits light at the specified light emission strength.

Although FIG. 9 illustrates only a part corresponding to one light-emitting element 602, the current drive unit 1004 may actually have the same number of such circuits as there are light-emitting elements 602 (e.g., 748×4=2992). However, the DAC 1101 may be shared by a plurality of light-emitting elements 602. In addition, when the power-saving mode is adopted in the light-emitting chip 400, the circuit portion 406 may further include a switch capable of allowing and stopping the application of the source voltage VCC to the current drive unit 1004.

In the present embodiment, the I/F circuit 1001 may receive data of the following data types from the communication I/F 715:
image data
setting data
disablement data

As described above, the image data is a sequence of signal values indicating whether the drive signal output to each light-emitting element should be on or off. The setting data indicates at least one setting value to be written to the register 1002, and a corresponding address in the register. The disablement data is data sent from the communication I/F 715 to the I/F circuit 1001 to switch the operating state of the I/F circuit 1001. Each of these types of data are sent serially over the data signal line DATAn in accordance with the clock indicated by the clock signal.

The I/F circuit 1001 determines the type of data received from the communication I/F 715 on the basis of the identification information given to each at the beginning of the individual piece of data. The identification information may be constituted by two clocks' worth of bits from the rise of the synchronization signal, for example. The following Table 1 shows an example of the correspondence relationship between signal levels of the two bits of the identification information (also called “identification bits”) and the data type.

TABLE 1
Correspondence relationship between signal level
of identification information and data type

| Bit #1 | Bit #2 | Data Type |
|---|---|---|
| High | High | Image Data |
| High | Low | Setting Data |
| Low | High or Low | Disablement Data |

According to the example in Table 1, if the first bit of the identification information is at high level and the second bit is also at high level, the image data is transmitted after the identification information. If the first bit of the identification information is at high level and the second bit is at low level, the setting data is transmitted after the identification information. If the first bit of the identification information is at low-level, the disablement data is transmitted after the identification information regardless of the signal level of the second bit. Note that the correspondence relationship between the signal levels of the identification information and the data type is not limited to the example in Table 1. For example, a correspondence relationship in which the high level and the low level are swapped may be employed.

The I/F circuit 1001 switches, in accordance with the data type determined on the basis of the identification information described above, a destination to which the subsequent data is to be output between the register 1002 and the data holding unit 1003. For example, if the identification information indicates image data, the I/F circuit 1001 outputs the subsequent data (along with the clock signal and the line synchronization signal) to the data holding unit 1003. If the identification information indicates setting data, the I/F circuit 1001 outputs the subsequent data (along with the clock signal and the line synchronization signal) to the register 1002 (writes the value of the control parameter to the specified address in the register 1002). If the identification information indicates disablement data, the I/F circuit 1001 may ignore the subsequent data.

In a case where the identification information indicates setting data, the I/F circuit 1001 switches between data writing to the register 1002 and data reading from the register 1002 in accordance with the access control information received after the identification information. The access control information may be constituted by one clock's worth of bits (also called “access control bits”) that follow the identification information. For example, the access control bits may indicate a data write instruction by low level and a data read instruction by high level, or vice versa.

FIG. 10 is a timing chart illustrating a case where image data is sent from the communication I/F 715 to the light-emitting chips 400-1 to 400-20. Changes in signal levels, along the time axis, in the clock signal (CLK), the line synchronization signal (SYNC), and the data signals on the signal lines DATA1, DATA2, and so on up to DATA19 and DATA20, are illustrated, in order from the top of the figure. The clock signal and the line synchronization signal are signals which are common across the plurality of light-emitting chips 400.

The clock signal (CLK) provides a clock for distinguishing each bit of the signals. The frequency of the clock signal may be 30 MHz, for example. The communication I/F 715 can generate a clock signal of a desired frequency by frequency-converting a reference clock generated by the clock generation unit 711.

The line synchronization signal (SYNC) indicates, with the rise of the signal level, the start timing of each line cycle in which the photosensitive member 102 rotates by an angle equivalent to one pixel in a circumferential direction D2. For example, if the resolution is 1200 dpi (the pixel pitch is approximately 21.16 μm) and the movement speed of the surface of the photosensitive member 102 is 200 mm/s, the length of one line cycle is approximately 105.8 us.

The data signals (DATA1 to DATA20) are output to the twenty light-emitting chips 400-1 to 400-20 in parallel. Starting from the rise of the line synchronization signal, the first two bits of each data signal are identification information indicating high level. Effective pixel values continue from the third bit on, and the pixel values corresponding to 2992 (=748×4) light-emitting elements 602 for each light-emitting chip 400 are transmitted serially by the end of the line cycle of approximately 105.8 us.

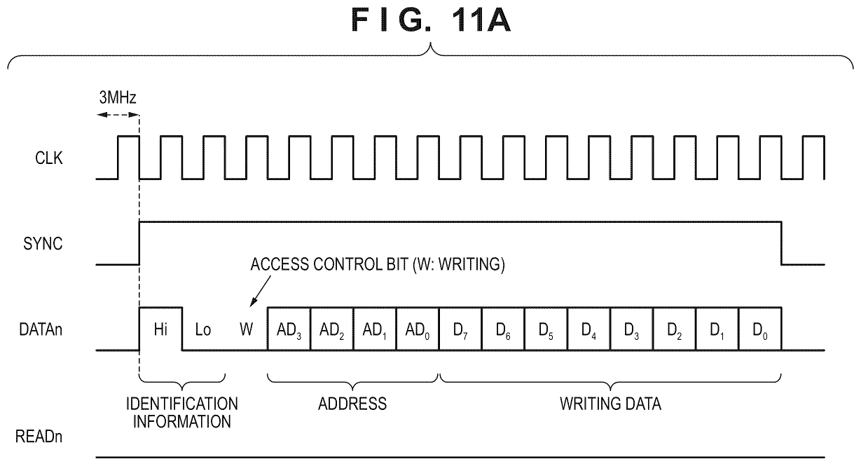

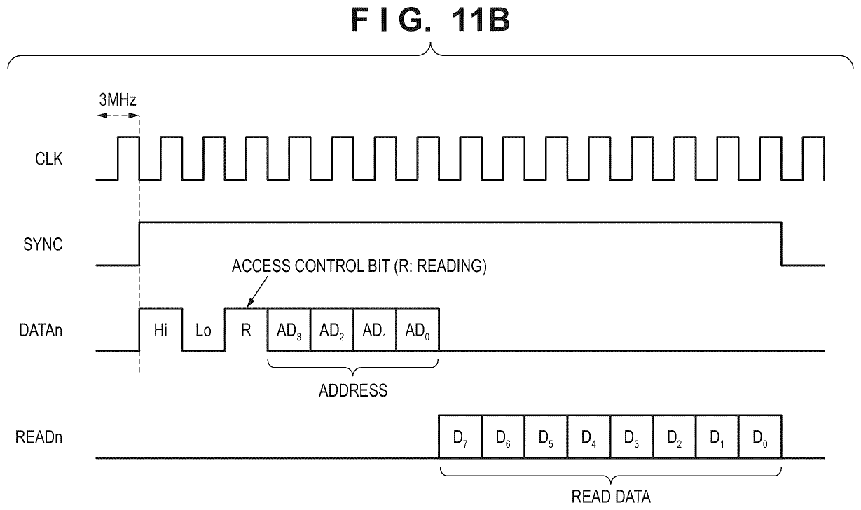

FIG. 11A is a timing chart illustrating a case where the setting data is sent from the communication I/F 715 to the light-emitting chips 400-1 to 400-20 (i.e., a case where the setting values are written into the register 1002). Changes in signal levels, along the time axis, in the clock signal (CLK), the synchronization signal (SYNC), the data signal on the signal line DATAn, and the data signal on the signal line READn, are illustrated, in order from the top of the figure. The data signal on the signal line DATAn is a signal sent to the light-emitting chip 400-n, and the data signal on the signal line READn is a signal returned from the light-emitting chip 400-n.

The frequency of the clock signal (CLK) for sending and receiving the setting data is, for example, 3 MHz, which may be different from the frequency of the clock signal for sending and receiving the image data. The communication I/F 715 can generate a clock signal of a desired frequency by frequency-converting a reference clock generated by the clock generation unit 711. Here, the synchronization signal (SYNC) serves as an enable signal indicating the period during which communication of the setting data is enabled, and is at high level during the communication period.

The data signal (DATAn, n=1, . . . , 20) is sent in accordance with the clock signal starting from the rise of the synchronization signal. The first two bits of each data signal are identification information that identifies the setting data, and are constituted by a high-level first bit followed by a low-level second bit. The third bit following the identification information is an access control bit, and indicates, for example, writing (W) to the register 1002 by low level, i.e., the sending of data from the communication I/F 715 to the light-emitting chip 400. The fourth to seventh bits indicate the address in the register 1002. When the identification information indicates setting data and the access control bit indicates writing (W), the I/F circuit 1001 writes the information indicated by the eighth to 15th bits of the data signal to the specified address of the register 1002. Of course, the sizes of the address and data are not limited to the examples illustrated here.

FIG. 11B is a timing chart illustrating a case where the setting data is received from the light-emitting chips 400-1 to 400-20 by the communication I/F 715 (i.e., a case where the setting values are read out from the register 1002).

The frequency of the clock signal (CLK) for sending and receiving the setting data may be, for example, 3 MHz, as in the example in FIG. 11A. Here, too, the synchronization signal (SYNC) serves as an enable signal indicating the period during which communication of the setting data is enabled, and is at high level during the communication period.

The data signal (DATAn, n=1, . . . , 20) is sent in accordance with the clock signal starting from the rise of the synchronization signal. The first two bits of each data signal are identification information that identifies the setting data, and are constituted by a high-level first bit followed by a low-level second bit. The third bit following the identification information is an access control bit, and indicates, for example, reading (R) from the register 1002 by high level, i.e., the receiving of data from the light-emitting chip 400 by the communication I/F 715. The fourth to seventh bits indicate the address in the register 1002. When the identification information indicates setting data and the access control bit indicates reading (R), the I/F circuit 1001 reads out the information stored at the designated address in the register 1002, and returns that information as the eighth to 15th bits (D₇ to D₀) on the signal line READn.

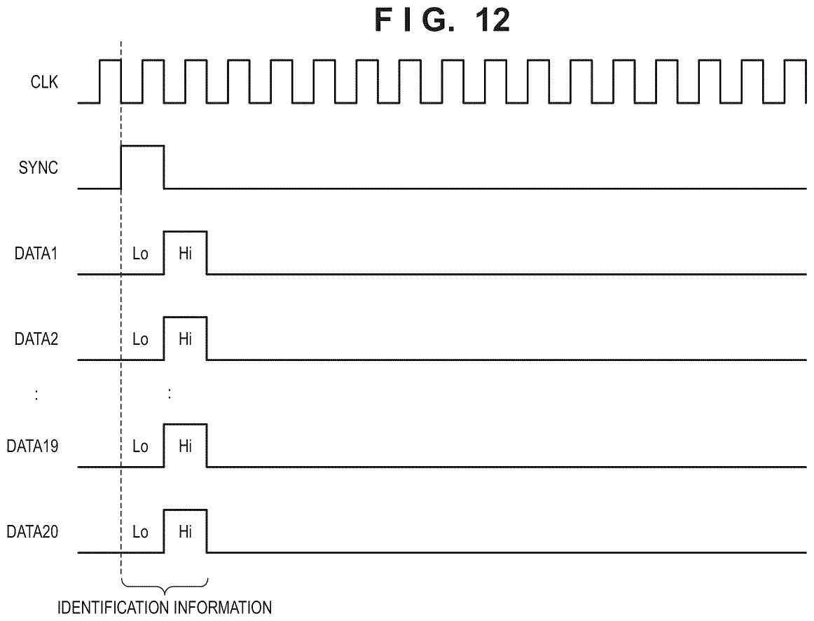

FIG. 12 is a timing chart illustrating a case where disablement data is sent from the communication I/F 715 to the light-emitting chips 400-1 to 400-20. Changes in signal levels, along the time axis, in the clock signal (CLK), the synchronization signal (SYNC), and the data signals on the signal lines DATA1, DATA2, and so on up to DATA19 and DATA20, are illustrated, in order from the top of the figure.

The frequency of the clock signal (CLK) may be 30 MHz, for example. The synchronization signal (SYNC) triggers the sending of the disablement data by rising to high level.

The data signals (DATA1 to DATA20), at the first bit among the identification information in the first two bits starting from the rise of the synchronization signal, goes to low level, which indicate that the disablement data is to be sent. Although the second bit is at high level in the example in FIG. 12, the second bit may be at low level. The data signals from the third bit on may all be at low level.

As can be seen from the foregoing descriptions, the I/F circuit 1001 operates in one of the following two states:
First state: writing the setting information received from the communication I/F 715 to the register 1002, or sending the setting information read out from the register 1002 to the communication I/F 715
Second state: outputting the image data received from the communication I/F 715 to the light-emitting element array

In addition, the above-described disablement data is incorporated to prevent irregular transitions between operating states caused by external disturbances such as noise or static electricity. In other words, the communication I/F 715 sends the disablement data to the light-emitting chips 400-1 to 400-20 when switching the operating state of the I/F circuit 1001 between the first state and the second state. When the disablement data is received, each light-emitting chip 400 transitions to an intermediate state between the first state and the second state, and then transitions to the first state or the second state on the basis of the identification information added to the received data. When the image data is received without the disablement data being received while operating in the first state, the I/F circuit 1001 keeps operating in the first state. Likewise, when the setting data is received without the disablement data being received while operating in the second state, the I/F circuit 1001 keeps operating in the second state.

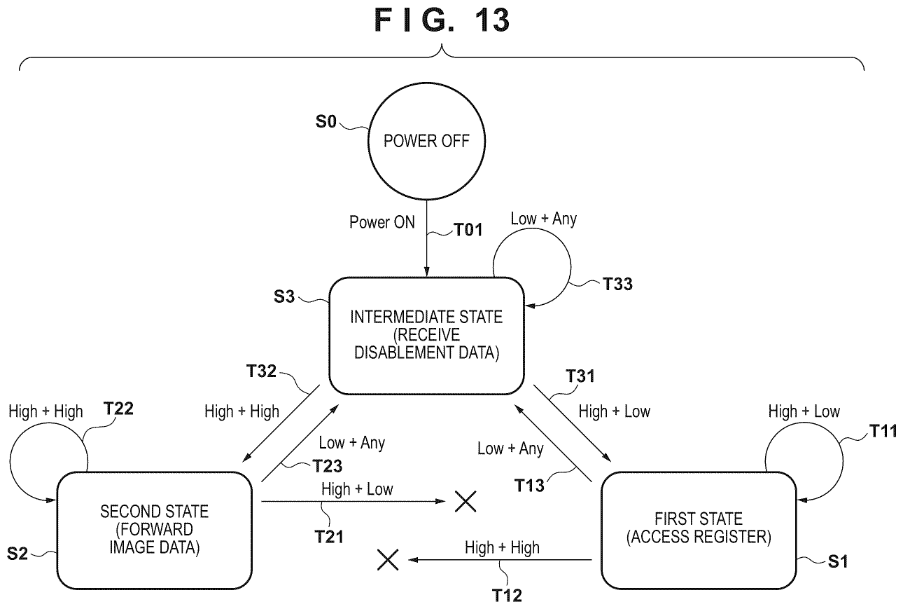

FIG. 13 is a state transition diagram illustrating restrictions on transitions in the operating state of the I/F circuit 1001. In addition to a power off state S0, the I/F circuit 1001 has three operating states, namely a first state S1, a second state S2, and an intermediate state S3.

When the source voltage VCC is applied, the I/F circuit 1001 transitions from the power off state S0 to the intermediate state S3. The intermediate state S3 is a state that occurs immediately after the disablement data has been received (or immediately after the power having been turned on). Upon receiving the identification bit “High+Low” indicating setting data in the intermediate state S3, the I/F circuit 1001 transitions to the first state (a transition T31). Upon receiving the identification bit “High+High” indicating image data in the intermediate state S3, the I/F circuit 1001 transitions to the second state (a transition T32). Upon receiving the identification bit “Low+Any” indicating disablement data in the intermediate state S3, the I/F circuit 1001 stays in the intermediate state (a transition T33). Note that “Any” means either “High” or “Low”.

Upon receiving the identification bit “High+Low” indicating setting data in the first state S1, the I/F circuit 1001 stays in the first state (a transition T11). Even if the identification bit “High+High” indicating image data is received in the first state S1, the I/F circuit 1001 stays in the first state, ignoring the subsequent data because a transition T12 to the second state is prohibited. Upon receiving the identification bit “Low+Any” indicating disablement data in the first state S1, the I/F circuit 1001 transitions to the intermediate state (a transition T13).

Even if the identification bit “High+Low” indicating setting data is received in the second state S2, the I/F circuit 1001 stays in the second state, ignoring the subsequent data, because a transition T21 to the first state is prohibited. Upon receiving the identification bit “High+High” indicating image data in the second state S2, the I/F circuit 1001 stays in the second state (a transition T22). Upon receiving the identification bit “Low+Any” indicating disablement data in the second state S2, the I/F circuit 1001 transitions to the intermediate state (a transition T23).

Interposing the intermediate state between the first state and the second state in this manner makes it possible to avoid a situation where incorrect data is written to the register 1002 or output to the light-emitting element 602, even when an error in sending the identification bit has occurred due to an external disturbance.

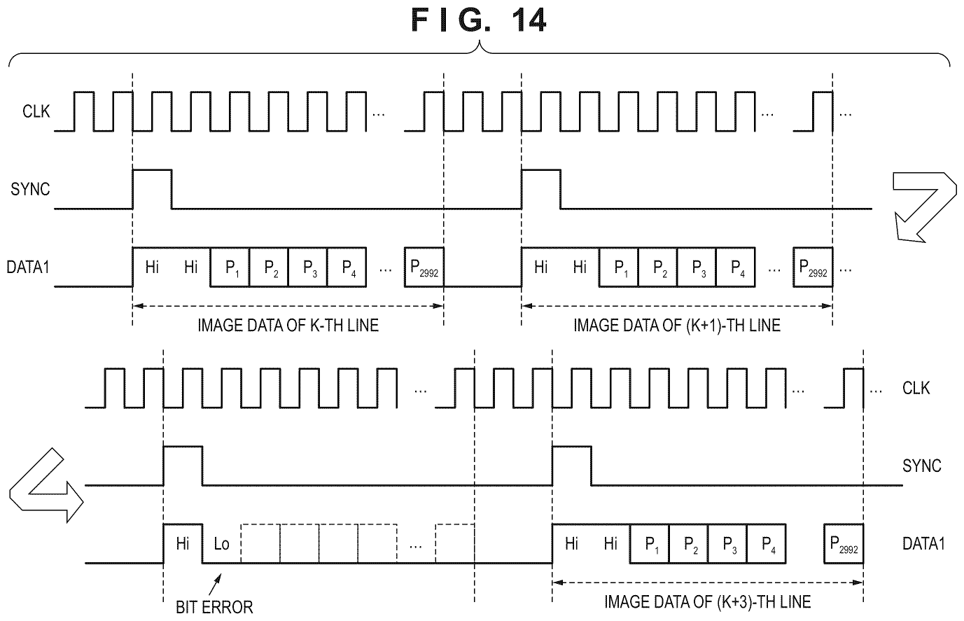

FIG. 14 is a timing chart illustrating data communication in a scenario in which an error in the interpretation of identification information occurs while image data is being sent. FIG. 14 illustrates the transmission of a k-th line to a k+3-th line of the image data, which is sent to the signal line DATA1 for the light-emitting chip 400-1, along with the clock signal (CLK) and the line synchronization signal (SYNC). First, because the identification information of the k-th line is “High+High”, the I/F circuit 1001 of the light-emitting chip 400-1 operates in the second state, sequentially receiving the image data for the 2,992 light-emitting elements in the k-th line, and outputting the image data to the data holding unit 1003. Next, because the identification information of the k+1-th line is also “High+High”, the I/F circuit 1001 of the light-emitting chip 400-1 stays in the second state, sequentially receiving the image data for the k+1-th line, and outputting the image data to the data holding unit 1003. Thereafter, an error occurs in the second bit of the identification information in the k+2-th line, and the identification information is interpreted as “High+Low”, which means setting data. However, the I/F circuit 1001 of the light-emitting chip 400-1 has not received the disablement data and is in the second state rather than the intermediate state. As such, the I/F circuit 1001 does not transition to the first state, and ignores the received bit string following the incorrect identification information. As a result, drive signals based on the image data of the k+1-th line continue to be supplied to the 2,992 light-emitting elements without being updated, and the image of the k+2-th line is the same as the image of the k+1-th line. Next, because the identification information of the k+3-th line is “High+High”, the I/F circuit 1001 of the light-emitting chip 400-1 stays in the second state, sequentially receiving the image data for the k+3-th line, and outputting the image data to the data holding unit 1003.

Here, assume a case where the first bit of the identification information of the k+2-th line is incorrectly interpreted as “Low” (i.e., the disablement data), and that the second bit of the identification information of the k+3-th line is incorrectly interpreted as “Low” (i.e., the setting data). In this case, the I/F circuit 1001 would transition to the intermediate state in response to receiving the disablement data, and then mistakenly transition to the first state for receiving the setting data. However, the probability of such a sending error occurring in succession by chance at the timing at which the two pieces of identification information are received is extremely low. Normally, even if the identification information that was expected to indicate image data is incorrectly interpreted as indicating disablement data, the next identification information again indicates image data, and thus the I/F circuit 1001 may appropriately return to the second state.

### 4. Separate Setting Mode and Common Setting Mode

As described above, the communication I/F 715 can send setting information for setting the operations of the respective light-emitting chips 400 to the plurality of light-emitting chips 400, which are slave devices. The setting information is written into the register 712 of the image controller 710 by the CPU 701, read out by the setting data processing unit 714, and sent to the light-emitting chips 400 by the communication I/F 715. Accordingly, to send the setting information to the twenty light-emitting chips 400-1 to 400-20, it is necessary for the CPU 701 to write the setting information to the register 712 twenty times over the serial communication line. However, at least some of the setting information is information to be applied to the plurality of light-emitting chips 400 in common. Accordingly, the present embodiment provides a mechanism which makes it possible to omit such redundancy in writing of common setting information into the register 712.

In the present embodiment, the communication I/F 715 operates in one of a first operating mode and a second operating mode pertaining to the sending of the setting information to the plurality of light-emitting chips 400. The first operating mode is a mode in which a plurality of pieces of separate setting information read out from the first storage area 721 of the register 712 are sent to respective ones of the plurality of light-emitting chips 400. The following descriptions will refer to the first operating mode as a “separate setting mode”. The second operating mode is a mode in which common setting information read out from the first storage area 721 of the register 712 is sent to the plurality of light-emitting chips 400. The following descriptions will refer to the second operating mode as a “common setting mode”. The second storage area 722 of the register 712 stores control information indicating whether the communication I/F 715 is to operate in the separate setting mode or the common setting mode. When the control information written into the second storage area 722 indicates a first value, the communication I/F 715, together with the setting data processing unit 714, operates in the separate setting mode. Meanwhile, when the control information written into the second storage area 722 indicates a second value, the communication I/F 715, together with the setting data processing unit 714, operates in the common setting mode.

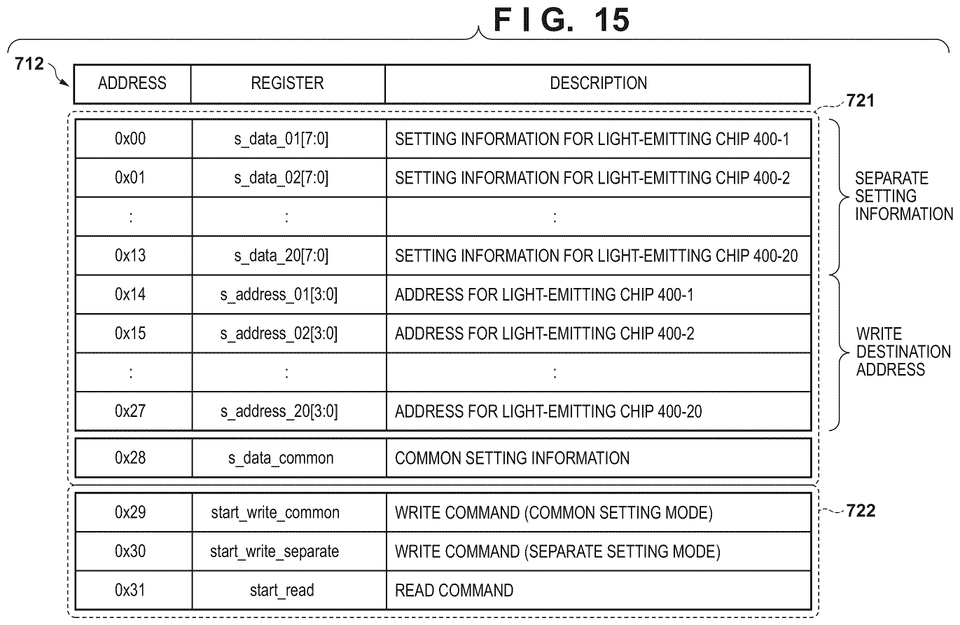

FIG. 15 is a table showing an example of the configuration of the register 712 of the image controller 710. As described above, the register 712 includes the first storage area 721 and the second storage area 722. In the example in FIG. 15, the first storage area 721 is a storage area from addresses ‘0x00’ to ‘0x28’, represented by hexadecimal numbers. The second storage area 722 is a storage area from addresses ‘0x29’ to ‘0x31’.

The addresses ‘0x00’ to ‘0x13’ in the first storage area 721 store separate setting information (s_data_01, s_data_02, and so on up to s_data_20) to be separately applied to respective ones of the light-emitting chips 400-1 to 400-20. The individual piece of separate setting information may be 8 bits, for example. The addresses ‘0x14’ to ‘0x27’ in the first storage area 721 store respective addresses (s_address_01, s_address_02, and so on up to s_address_20) of the registers 1002 in the light-emitting chips 400-1 to 400-20 where the corresponding separate setting information is to be written. The individual piece of address information may be 4 bits, for example. The address ‘0x28’ in the first storage area 721 stores common setting information (s_data_common) to be applied to the light-emitting chips 400-1 to 400-20 in common. The common setting information may be as high as 8 bits, and is 1 bit in the example in FIG. 15.

The address ‘0x29’ in the second storage area 722 stores a flag (start_write_common) for indicating a write operation in the common setting mode to the communication I/F 715. The address ‘0x30’ in the second storage area 722 stores a flag (start_write_separate) for indicating a write operation in the separate setting mode to the communication I/F 715. The address ‘0x31’ in the second storage area 722 stores a flag (start_read) for indicating a readout operation to the communication I/F 715. All three of these flags may be 1 bit. Note that the configurations of the first storage area 721 and the second storage area 722 are not limited to the example described above. For example, a write operation in the common setting mode or a write operation in the separate setting mode may be indicated by two values of a single flag for setting the operating mode.

When indicating a write operation in the separate setting mode, the CPU 701 writes a value of ‘1’ to the address ‘0x30’ in the second storage area 722. The values of the other two flags may be ‘0’. The setting data processing unit 714 and the communication I/F 715 start the write operation in the separate setting mode when the flag start_write_separate at the address ‘0x30’ indicates a value of ‘1’ (the first value). In the separate setting mode, for the light-emitting chip 400-1, the setting data processing unit 714 outputs, to the communication I/F 715, setting data constituted by the separate setting information read out from the address ‘0x00’ and the address information read out from the address ‘0x14’. The communication I/F 715 adds access control information to this setting data for the light-emitting chip 400-1 and sends the resulting data to the light-emitting chip 400-1. For the light-emitting chip 400-2, the setting data processing unit 714 also outputs, to the communication I/F 715, setting data constituted by the separate setting information read out from the address ‘0x01’ and the address information read out from the address ‘0x15’. The communication I/F 715 adds access control information to this setting data for the light-emitting chip 400-2 and sends the resulting data to the light-emitting chip 400-2. The setting data is sent to the other light-emitting chips 400 in the separate setting mode in the same manner.

For example, a first address in the register 1002 of each light-emitting chip 400 is an address that holds a separate adjustment value for light intensity of the light-emitting element array of that light-emitting chip 400. A second address in the register 1002 of each light-emitting chip 400 is an address that holds a separate setting value indicating that the power-saving mode should be on or off, and other setting information, for that light-emitting chip 400. The CPU 701 writes a value for these first or second address (or other address) into each of the addresses ‘0x14’ to ‘0x27’ in the first storage area 721, according to the purpose of the setting.

When indicating a write operation in the common setting mode, the CPU 701 writes a value of ‘1’ to the address ‘0x29’ in the second storage area 722. The values of the other two flags may be ‘0’. The setting data processing unit 714 and the communication I/F 715 start the write operation in the common setting mode when the flag start_write_common at the address ‘0x29’ indicates a value of ‘1’ (the second value). In the common setting mode, the communication I/F 715 sends the setting data, including the common setting information read out from the address ‘0x28’, to the light-emitting chips 400-1 to 400-20. As an example, the address in the register 1002 to which the common setting information is written in the common setting mode may be the same as the address to which the separate setting information, stored at the addresses ‘0x14’ to ‘0x27’, is written. As another example, the first storage area 721 may further store control information (not shown) indicating an address in the register 1002 to which the common setting information is written in the common setting mode.

In a certain practical example, in the common setting mode, the communication I/F 715 overwrites part of the separate setting information read out from the first storage area 721 with the common setting information, and sends the common setting information to the light-emitting chips 400-1 to 400-20 with the remaining part of the separate setting information. For example, turning the power-saving mode on or off can be indicated by a 1-bit setting value, and this is less than 8 bits, which is the maximum size of the setting information that can be sent in a single sending operation. Accordingly, defining a specific signal position in the 8-bit signal sequence in advance as a bit for setting the power-saving mode makes it possible for the bit at that signal position to be uniformly interpreted as a bit for setting the power-saving mode, regardless of the operating mode. Other signal positions may be utilized for other setting information. In other words, in this practical example, each of the light-emitting chips 400-1 to 400-20 interprets the setting information received through the corresponding data signal line according to a certain signal format independent of the operating mode of the communication I/F 715. The signal positions defined in advance in the signal format are shared for the purpose of sending the separate setting values in the separate setting mode and sending the common setting values in the common setting mode. According to this configuration, processing need not be implemented differently depending on the operating mode of the communication I/F 715 in the light-emitting chip 400, which makes it possible to avoid complicating the configuration of the light-emitting chip 400 and suppress an increase in the manufacturing cost of the apparatus.

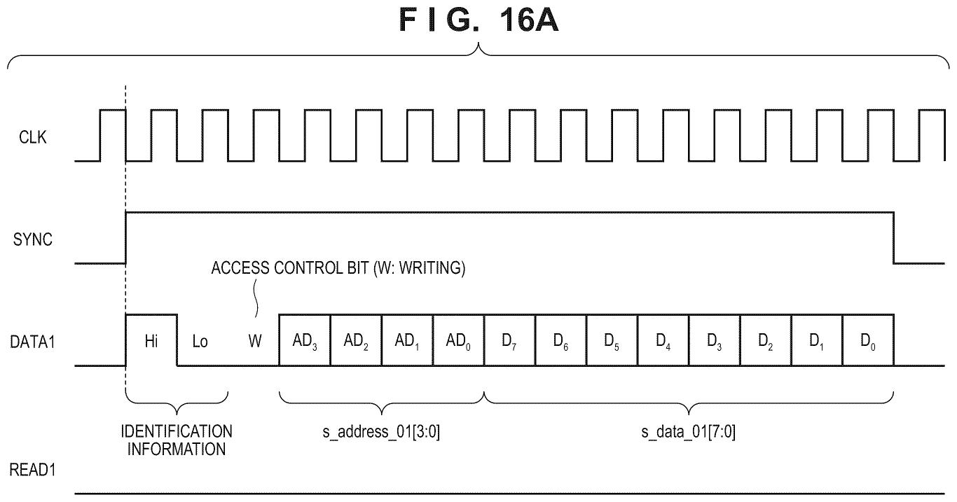

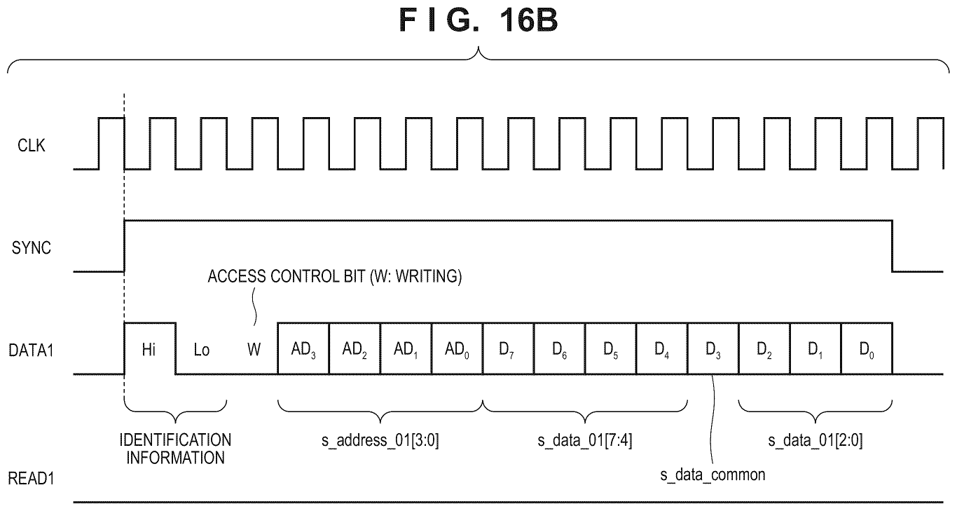

FIG. 16A is a timing chart of sending of setting data to the light-emitting chips 400 in the separate setting mode. FIG. 16B is a timing chart of sending of setting data to the light-emitting chips 400 in the common setting mode. Although only the sending of the setting data to the light-emitting chip 400-1 is illustrated in these figures, the sending of the setting data to the light-emitting chips 400-2 to 400-20 may be performed in the same manner.

It is also assumed here that the size of the separate setting information is 8 bits, and the size of the common setting information is 1 bit. Furthermore, it is assumed that in the signal format for sending the setting data, a fifth signal position D₃ in the signal sequence D₇ to D₀ is defined to represent the setting value of the power-saving mode.

As described with reference to FIG. 11A, the frequency of the clock signal (CLK) for sending and receiving the setting data may be 3 MHz, for example. The synchronization signal (SYNC) goes to high level during the communication period of the setting data. In both FIGS. 16A and 16B, the first two bits of the data signal (DATA1) are identification information that identifies the setting data, and are constituted by a high-level first bit followed by a low-level second bit. The third bit following the identification information is an access control bit, and indicates, for example, writing (W) to the register 1002 by low level. The fourth to seventh bits indicate a bit string s_address_01 [3:0] obtained from the first storage area 721 as the address to which the setting information is to be written. Here, X and Y in [X: Y] represent the positions of digits, and Z[X:Y] means the X-th digit to the Y-th digit of the variable Z. The eighth to 15th bits indicate the setting information to be written to the specified address in the register 1002 of the light-emitting chip 400-1.

Referring to FIG. 16A, the setting information D₇ to Do of the eighth to 15th bits in the separate setting mode indicates a bit string s_data_01 [7:0] obtained from the first storage area 721. This is an 8-bit separate setting value for the light-emitting chip 400-1. On the other hand, referring to FIG. 16B, the setting information D₇ to Do of the eighth to 15th bits in the common setting mode indicates the following values:

```
  • D₇ to D₄ = s_data_01 [7:4]
    (seventh digit to fourth digit of the separate setting value
s_data_01)
  • D₃ = s_data_common
    (common setting value)
  • D₂ to D₀ = s_data_01 [2:0]
    (second digit to 0-th digit of the separate setting value
s_data_01)
```

In other words, compared to the example in FIG. 16A, in the common setting mode, the common setting value is overwritten at the fifth signal position D₃ in the setting information. However, the light-emitting chip 400-1 sets the operation of the light-emitting chip 400-1 by interpreting the received setting information in a fixed signal format, regardless of whether the communication I/F 715 is operating in the separate setting mode or the common setting mode.

When indicating a readout operation, the CPU 701 writes a value of ‘1’ to the address ‘0x31’ in the second storage area 722. The values of the other two flags may be ‘0’. The setting data processing unit 714 and the communication I/F 715 start the readout operation when the flag start_read at the address ‘0x31’ indicates a value of ‘1’. In the readout operation, the setting information read out from the specified address of the registers 1002 of the light-emitting chips 400-1 to 400-20 is output to the CPU 701 in order.

As an example of the application of the above-described operating modes, the CPU 701 may write separate adjustment values for light intensity to the register 712 during initial settings made before the product is shipped, and set the communication I/F 715 to the separate setting mode. In this case, the communication I/F 715, which operates in the separate setting mode, sends the separate adjustment values read out from the register 712 to the light-emitting chips 400-1 to 400-20, respectively. As a result, the photosensitive member 102 is exposed at a light intensity uniform throughout the plurality of light-emitting chips 400, which makes it possible to form a high-quality image in which light intensity unevenness is eliminated.

As another example, the CPU 701 may, before the execution of a print job is started, write separate setting values for the power-saving mode into the register 712 to ensure a voltage is not applied to the light-emitting element array(s) outside the range of the sheet size used, and set the communication I/F 715 to the separate setting mode. In this case, the communication I/F 715, which operates in the separate setting mode, sends the separate setting values read out from the register 712 to the light-emitting chips 400-1 to 400-20, respectively. As a result, the power-saving mode is enabled for several of the light-emitting chips 400 located at the left and right ends in the main scanning direction, and the application of voltage to the unused light-emitting element arrays is stopped, which makes it possible to reduce the power consumed by the exposure head 106.

As another example, the CPU 701 may write the common setting value to the register 712 for suspending the application of voltage to the light-emitting element arrays during intervals between consecutive sheets when executing a print job that spans a plurality of sheets, and set the communication I/F 715 to the common setting mode. In this case, the communication I/F 715, which operates in the common setting mode, sends the common setting value read out from the register 712 to the respective light-emitting chips 400-1 to 400-20. As a result, the application of voltage to the light-emitting element arrays of all the light-emitting chips 400 is suspended, which also makes it possible to reduce the power consumed by the exposure head 106. In this example, writing redundant setting values from the CPU 701 to the register 712 is omitted. This reduces the time required for communication control and improves the productivity of job execution.

Note that the signal position at which the common setting value is sent in the signal format for sending the setting data is not limited to the practical example described above. For example, the communication I/F 715 may send the common setting value at different signal positions depending on the write destination address indicated by the address information in the first storage area 721 of the register 712. Alternatively, the communication I/F 715 may change the signal position at which the common setting value is sent on the basis of additional control information (not shown) read out from the second storage area 722 of the register 712.

### 5. Flow of Processing

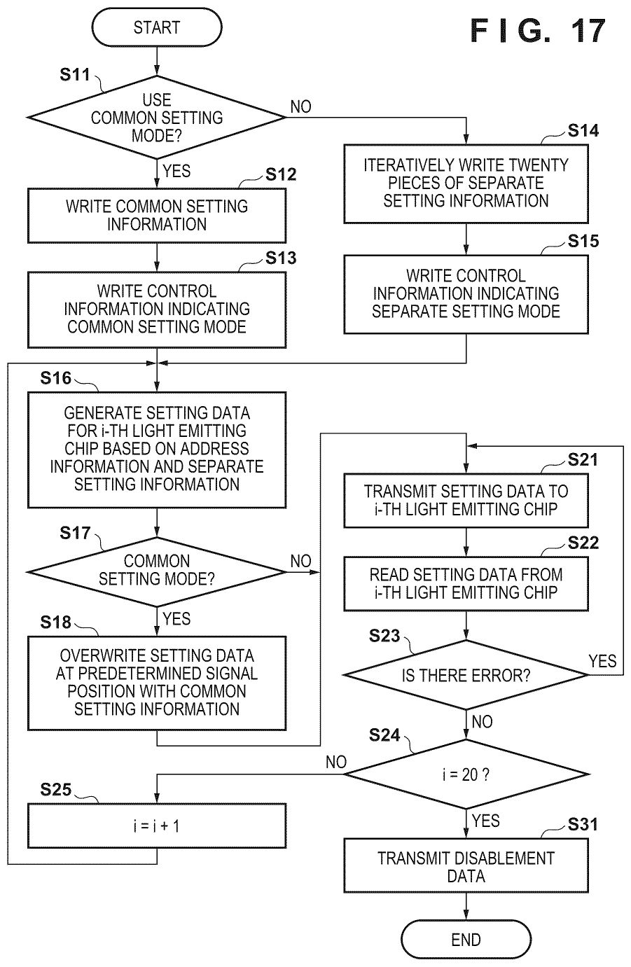

FIG. 17 is a flowchart illustrating an example of a flow of chip setting processing that can be performed by the communication system 200 according to the above-described embodiment. The chip setting processing illustrated in FIG. 17 can be performed by the communication system 200 during initial settings before the product is shipped, and at any desired point in time when it is necessary to change the settings of the light-emitting chips 400, such as before, during, or after execution of a print job. It is assumed that predetermined setting information for the light-emitting chips 400-1 to 400-20 has been written into the first storage area 721 of the register 712 of the image controller 710 at the start of the communication processing. Note that in the following descriptions, the processing steps will be indicated by an “S”.

First, in step S11, the communication processing branches depending on whether the common setting mode or the separate setting mode is to be used as the operating mode for setting the light-emitting chips 400-1 to 400-20. The sequence moves to step S12 when the common setting mode is to be used. On the other hand, the sequence moves to step S14 when the separate setting mode is to be used.

In step S12, the CPU 701 writes the common setting information, to be applied in common to the light-emitting chips 400-1 to 400-20, into the first storage area 721 of the register 712 over the serial communication line 211. For example, the CPU 701 performs a single write operation to the address ‘0x28’ (s_data_common) in the first storage area 721. Then, in step S13, the CPU 701 writes control information including a value indicating the common setting mode to the second storage area 722 of the register 712 (e.g., start_write_common=‘1’, start_write_separate=‘0’).

On the other hand, in step S14, the CPU 701 writes 20 pieces of separate setting information, to be applied separately to the light-emitting chips 400-1 to 400-20, into the first storage area 721 of the register 712 over the serial communication line 211. For example, the CPU 701 performs twenty write operations to the addresses ‘0x00’ to ‘0x13’ (s_data_01 and so on up to s_data_20) in the first storage area 721. Note that the CPU 701 also performs repeated operation to write address information for the addresses ‘0x14’ to ‘0x27’ (s_address_01 and so on up to s_address_20) in the first storage area 721 as necessary. Then, in step S15, the CPU 701 writes control information including a value indicating the separate setting mode to the second storage area 722 of the register 712 (e.g., start_write_common=‘0’, start_write_separate=‘1’).

Steps S16 to S24 are then repeated for each of the twenty light-emitting chips 400-1 to 400-20. Hereinafter, the default value of the variable i is 1.

In step S16, the setting data processing unit 714 generates setting data for the i-th light-emitting chip 400-i on the basis of the i-th address information and the separate setting information read out from the first storage area 721.

Then, in step S17, the setting data processing unit 714 refers to the control information written into the second storage area 722, and determines whether the operating mode of the communication I/F 715 is the common setting mode or the separate setting mode. If the operating mode of the communication I/F 715 is the common setting mode, in step S18, the setting data processing unit 714 overwrites the predetermined signal position in the setting data generated in step S16 with the common setting value read out from the first storage area 721. Meanwhile, if the operating mode of the communication I/F 715 is the separate setting mode, step S18 is skipped.

Then, in step S21, the communication I/F 715 sends the setting data for the i-th light-emitting chip 400-i generated by the setting data processing unit 714 to the light-emitting chip 400-i over the data signal line DATAi. The light-emitting chip 400-i stores the setting information in the specified address in the register 1002 on the basis of the address information in the setting data received from the communication I/F 715.

Then, in step S22, operating in readout mode, the communication I/F 715 receives, from the i-th light-emitting chip 400-i, the setting information read out from the same address as the address specified in step S21. The communication I/F 715 outputs the received setting information to the CPU 701 via the setting data processing unit 714.

Then, in step S23, the CPU 701 verifies whether the setting information read out from the i-th light-emitting chip 400-i in step S22 matches the setting information to be written to the light-emitting chip 400-i. If the setting information does not match, a write error is determined to have occurred; the sequence returns to step S21, where the setting data is re-sent to the i-th light-emitting chip 400-i. If the setting information matches, the write is determined to have been successful, and the sequence moves to step S24.

In step S24, the CPU 701 determines whether the variable i has reached 20, which is the number of light-emitting chips 400. If the variable i has not reached 20, the variable i is incremented in step S25, and the above-described steps S16 to S24 are repeated for the next light-emitting chip 400-i. If the variable i has reached 20, the sequence moves to step S31.

In step S31, the communication I/F 715 sends the disablement data to the light-emitting chips 400-1 to 400-20. This enables the I/F circuit 1001 of the light-emitting chips 400-1 to 400-20 to transition among different states.

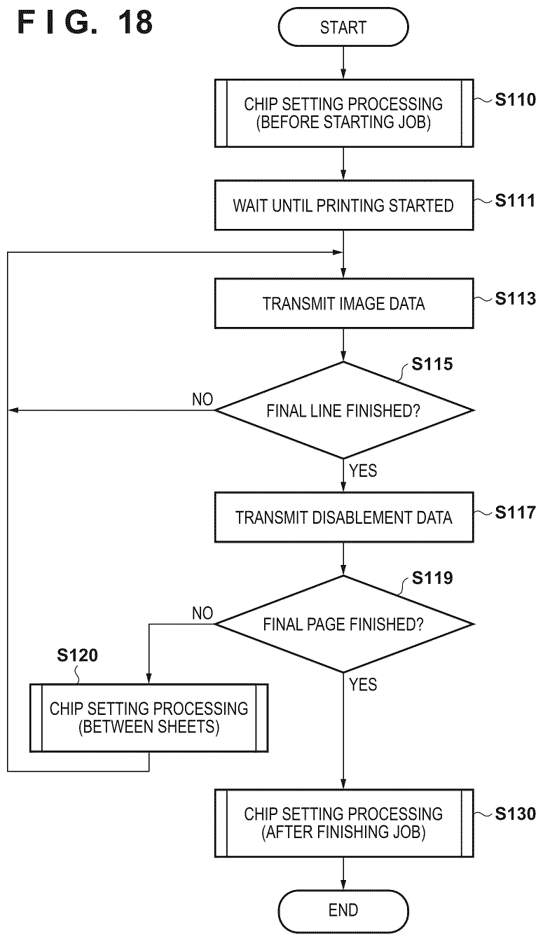

FIG. 18 is a flowchart illustrating an example of a flow of job control processing that can be performed by the communication system 200 according to the above-described embodiment. The job control processing illustrated in FIG. 18 can be started, for example, in response to receiving a print job from a user, and performed by the CPU 701 and the image controller 710 working cooperatively.

First, in step S110, prior to executing the print job, the communication I/F 715 performs the chip setting processing described with reference to FIG. 17, under the control of the CPU 701. For example, the communication I/F 715 may operate in the separate setting mode, and send the separate adjustment values to the light-emitting chips 400-1 to 400-20 for separately adjusting the light intensity of the light-emitting element arrays 1005. Additionally, or alternatively, the communication I/F 715 may operate in the separate setting mode, and send the separate setting values to the corresponding light-emitting chips 400 to ensure the voltage is not applied to the light-emitting element arrays 1005 outside the range of the sheet size.

Then, in step S111, the communication I/F 715 stands by until a sheet is conveyed to a predetermined position. When the timing at which the printing (light emission control) is to be started arrives, the sequence moves to step S113.

In step S113, the communication I/F 715 sends one line's worth of image data to the light-emitting chips 400-1 to 400-20 during a line cycle indicated by the line synchronization signal. The light-emitting element array 1005 of the light-emitting chips 400-1 to 400-20 is supplied with drive signals based on the image data received from the communication I/F 715. As a result, the light emitted from the light-emitting element arrays 1005 exposes the photosensitive member 102, and one line's worth of a latent image is formed on the surface of the photosensitive member 102.

The sending of the image data to the light-emitting chips 400-1 to 400-20 in step S113 is repeated until it is determined in step S115 that the data of the final line of the input image data has been sent. The sequence moves to step S117 when it is determined that the data of the final line has been sent. In step S117, the communication I/F 715 sends the disablement data to the light-emitting chips 400-1 to 400-20.

The subsequent processing branches depending on whether the printing of the final page of the print job has ended. If the printing of the final page has not ended, the sequence moves to step S120. Meanwhile, if the printing of the final page has ended, the sequence moves to S130.

Step S120 represents the chip setting processing during an interval between consecutive sheets while executing the print job that spans a plurality of sheets. In step S120, operating in the common setting mode, the communication I/F 715 sends, to the light-emitting chips 400-1 to 400-20, the common setting value for suspending the application of the voltage to the light-emitting element arrays 1005 (indicating the power-saving mode is to be turned on), for example. The application of the voltage to the light-emitting element arrays 1005 can be resumed by sending the common setting value indicating the power-saving mode is to be turned off to the light-emitting chips 400-1 to 400-20 immediately before the next sheet is conveyed to the predetermined position.

Step S130 represents the chip setting processing after the end of the execution of the print job. In step S130, operating in the common setting mode, the communication I/F 715 sends, to the light-emitting chips 400-1 to 400-20, the common setting value for stopping the application of the voltage to the light-emitting element arrays 1005, for example.

### 6. Conclusion

Thus far, various embodiments and practical examples of the technology according to the present disclosure have been described with reference to FIGS. 1 to 18. In the embodiments described above, the communication interface connected to a plurality of devices reads out a plurality of pieces of separate setting information from the first storage unit and sends that information to corresponding ones of the plurality of devices in a case where the control information written into the second storage unit by the control unit includes a first value indicating a separate setting mode. In a case where the control information written into the second storage unit includes a second value indicating the common setting mode, the communication interface reads out the common setting information from the first storage unit and sends that information to the plurality of devices. According to this configuration, it is possible to flexibly switch between sending the separate setting information and sending the common setting information to the plurality of devices. In the common setting mode, only one write operation is required for the control unit to write a setting value to be sent to a plurality of devices into the first storage unit. Accordingly, the load of the communication for setting the plurality of devices is reduced, the communication time is shortened, and the productivity is improved. In particular, the above-described embodiments are suited for operations when executing a print job in an image-forming apparatus in which a plurality of light-emitting chips are involved in the exposure of a photosensitive member.

Additionally, in the embodiments described above, when operating in a common setting mode, the communication interface may overwrite part of the separate setting information read out from the first storage unit with the common setting information, and send the remaining part of the separate setting information along with the common setting information to the plurality of devices. Each device may interpret the setting information received through the corresponding signal line according to a certain signal format, and it is not necessary to switch the setting operations depending on the operating mode of the communication interface. According to this configuration, it is possible to avoid complicating the configuration of each device and suppress an increase in the manufacturing cost of the apparatus.

Additionally, in the embodiments described above, the setting information can include a setting value for setting whether or not to apply a voltage to a drive circuit of a light-emitting element array in a light-emitting chip involved in exposing a photosensitive member. According to this configuration, a power-saving mode can be set separately for each light-emitting chip before and after execution of a print job, and the power-saving mode can be quickly turned on/off for all the light-emitting chips at once during the execution of the print job as well. This makes it possible to effectively reduce the power consumption in the light-emitting element arrays.

Although the present specification describes an example in which the communication system described above is implemented in an exposure apparatus of an image-forming apparatus that forms an image through an electrophotographic method, some embodiments are not limited to such an example. The communication system described above may be applied in an image-forming apparatus that forms an image through another method, and to an apparatus other than image-forming apparatuses.

Although some specific numerical values have been used for explanations in this specification, these specific numerical values are mere examples, and some embodiments are not limited to these specific numerical values used in the embodiments. Specifically, the number of light-emitting chips provided on one printed circuit board is not limited to twenty, and may be any number that is one or more. The size of the light-emitting element array in each light-emitting chip 400 is not limited to four rows*748 columns, and may be any other size. The pitch in the circumferential direction and the pitch in the axial direction of the light-emitting elements are not limited to about 21.16 μm and about 5 μm, and may take any other values.

### 7. Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-018020, which was filed on Feb. 8, 2024 and which is hereby incorporated by reference herein in its entirety.

What is claimed is:

1. A communication system comprising:
a plurality of devices;
a communication interface connected to the plurality of devices over a plurality of signal lines;
a first storage unit configured to store setting information to be sent from the communication interface to the plurality of devices;
a second storage unit configured to store control information indicating an operating mode of the communication interface; and
a processor configured to control operations of the communication interface by writing the control information into the second storage unit,
wherein the first storage unit is configured to store a plurality of pieces of separate setting information to be applied separately to the plurality of devices, and common setting information to be applied in common to the plurality of devices, and
the communication interface is configured to:
in a case where the control information written into the second storage unit includes a first value indicating a first operating mode, read out the plurality of pieces of separate setting information from the first storage unit and send the read-out pieces of separate setting information to the plurality of devices; and
in a case where the control information written into the second storage unit includes a second value indicating a second operating mode, read out the common setting information from the first storage unit and send the read-out common setting information to the plurality of devices.

2. The communication system according to claim 1, wherein the communication interface is configured to, in a case where the control information written into the second storage unit includes the second value, overwrite part of the separate setting information read out from the first storage unit with the common setting information read out from the first storage unit, and send the common setting information along with a remaining part of the separate setting information to the plurality of devices.

3. The communication system according to claim 2, wherein each of the plurality of devices interprets the setting information received via a corresponding one of the signal lines according to a certain signal format independent of the operating mode of the communication interface.

4. The communication system according to claim 3, wherein the common setting information is sent to each of the plurality of devices at a predefined signal position in the certain signal format.

5. The communication system according to claim 1, wherein the first storage unit and the second storage unit are different storage areas in the same register.

6. The communication system according to claim 5, wherein the communication interface is implemented on a first board along with the register, and
the processor is implemented on a second board different from the first board, and is configured to write information into the register over a serial communication line.

7. An image-forming apparatus that forms an image on a sheet, the image-forming apparatus comprising:
a photosensitive member; and
an exposure apparatus configured to expose the photosensitive member,
wherein the exposure apparatus includes a communication system including
a plurality of devices;
a communication interface connected to the plurality of devices over a plurality of signal lines;
a first storage unit configured to store setting information to be sent from the communication interface to the plurality of devices;
a second storage unit configured to store control information indicating an operating mode of the communication interface; and
a processor configured to control operations of the communication interface by writing the control information into the second storage unit,
wherein the first storage unit is configured to store a plurality of pieces of separate setting information to be applied separately to the plurality of devices, and common setting information to be applied in common to the plurality of devices, and
the communication interface is configured to:
in a case where the control information written into the second storage unit includes a first value indicating a first operating mode, read out the plurality of pieces of separate setting information from the first storage unit and send the read-out pieces of separate setting information to the plurality of devices; and
in a case where the control information written into the second storage unit includes a second value indicating a second operating mode, read out the common setting information from the first storage unit and send the read-out common setting information to the plurality of devices, and
wherein each of the plurality of devices is a light-emitting chip having a light-emitting element array used to expose the photosensitive member.

8. The image-forming apparatus according to claim 7, wherein the separate setting information includes separate setting values for setting whether or not to apply a voltage to a drive circuit of the light-emitting element array in each of the plurality of devices.

9. The image-forming apparatus according to claim 8, wherein the common setting information includes a common setting value for setting, in common, whether or not to apply a voltage to drive circuits of the light-emitting element arrays in the plurality of devices; and
the communication interface is configured to, in a case where the control information written into the second storage unit includes the second value, overwrite a signal position for the separate setting value in the separate setting information read out from the first storage unit with the common setting value read out from the first storage unit, and send the common setting value along with a remaining part of the separate setting information to the plurality of devices.

10. The image-forming apparatus according to claim 8, wherein the light-emitting element arrays of the plurality of devices are disposed along a main scanning direction parallel to a rotation axis of the photosensitive member, and
the communication interface is configured to operate in the first operating mode when a print job is executed, and send the separate setting value for preventing a voltage from being applied to the light-emitting element array outside a range of a sheet size to a corresponding device.

11. The image-forming apparatus according to claim 7, wherein the communication interface is configured to operate in the second operating mode in an interval between consecutive sheets during execution of a print job spanning a plurality of sheets, and send, to the plurality of devices, a common setting value for suspending application of a voltage to the light-emitting element arrays of the plurality of devices.

12. The image-forming apparatus according to claim 7, wherein the separate setting information includes a separate adjustment value for separately adjusting a light intensity of the light-emitting element array in each device.
